(19) United States
(12) Patent Application Publication
(10) Pub. No.: US 2008/0174691 A1
(43) Pub. Date: Jul. 24, 2008

(54) STROBED IMAGE ACQUISITION GUIDED BY RANGE SENSOR

(75) Inventors: Edward T. Polidor, Webster, NY (US); Robert Lea Jackson, Moorpark, CA (US); Richard DeKlotz, Moorpark, CA (US)

Correspondence Address: Stephen B. Salai, Esq.;Harter, Secrest & Emery LLP, 1600 Bausch & Lomb Place, Rochester, NY, 14604-2711, US

(73) Assignee: Quality Vision International Inc., Rochester, NY (US)

(21) Appl. No.: 11/625,089

(22) Filed: Jan. 19, 2007

(51) Int. Cl. H04N 5/232; G03B 13/00

(52) U.S. Cl. 348/348

(57) ABSTRACT

Apparatus for sequentially imaging an object while maintaining focus includes a camera having a selectable image capture mode, an objective lens optically coupled to the camera, an optical range sensor operating through the objective lens, a strobe illuminator, and a controller coupled to the camera, the illuminator and the range sensor sequentially activating and deactivating the range sensor, selecting and deselecting the image capture mode only when the range sensor is deactivated, and activating and deactivating the strobe illuminator only when the image capture mode is active.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “SEQUENCE LISTING”

Not applicable.

### BACKGROUND OF THE INVENTION

### Field of the Invention

This invention relates generally to image acquisition for automated systems and more particularly to an image acquisition camera system that uses a range sensor to maintain focus, which range sensor operates at a wavelength to which the image acquisition camera is sensitive.

The automated inspection of moving parts such as printed circuit boards relies heavily on the computer analysis of images created by digital or analog cameras that photograph the parts. In order to accurately analyze moving parts, the motion of the parts must be frozen to reduce blurring and to make accurate measurements. Stroboscopic light sources are known to be useful for this purpose as are fast shutters, either mechanical or electronic. A number of types of stroboscopic light sources are known for use in machine vision applications including coaxial illumination sources that direct the stroboscopic illumination through the same lens as is used by the camera, diffuse illumination that may be provided by a ring shaped light source surrounding the objective lens or the object being viewed, and back illumination that is generated from behind the object.

While it is possible to dynamically determine the distance from a camera to an object in a number of ways, it is desirable to do so using light that passes through the objective lens that the camera used to acquire the images. Furthermore, there are advantages to using a range sensor, such as a laser range sensor that uses light having a wavelength to which the camera used in the inspection system is sensitive. This approach permits the camera to be used for aligning the range sensor and makes it possible to ensure that the range sensor is properly aligned at the same location on the object being viewed as the camera. Similarly, coaxial illumination is widely preferred and through-the-lens coaxial illumination is most desirable.

The combination of all of these desirable features creates conflicts. The range sensor ideally will operate continuously, since in many applications the object being viewed is moving continuously rather than in a step-wise fashion. While the instantaneous variation of the distance between the camera and the object being viewed may be relatively small, the long term variation may be large, and consequently it is necessary to adjust the camera-to-object distance to maintain adequate focus. Preferably, the adjustment is made more or less continuously so that it may be made smoothly.

A problem arises from these competing requirements in that if the range sensor, which relies on light that is visible to the camera, operates at the same time that the camera is acquiring an image, the light from the range sensor will obscure part of the image. Heretofore, one approach to this problem has been to use off-axis, range-sensing lasers, and triangulation to monitor the distance from the camera to the object and thereby avoid having the light enter the camera. Another approach has been to use a laser-range-finding device mounted perpendicular to the measurement surface and a plurality of cameras mounted at angles to the surface.

### BRIEF SUMMARY OF THE INVENTION

Briefly stated and in accordance with a presently preferred embodiment of the invention, apparatus for sequentially imaging an object while maintaining focus includes a camera having a selectable image capture mode, an objective lens optically coupled to the camera, an optical range sensor operating through the objective lens, a strobe illuminator, and a controller coupled to the camera, the illuminator and the range sensor sequentially activating and deactivating the range sensor, selecting and deselecting the image capture mode only when the range sensor is deactivated, and activating and deactivating the strobe illuminator only when the image capture mode is active.

In accordance with another aspect of the invention the apparatus includes a focus controller coupled to the range sensor for maintaining the object in focus.

In accordance with still further aspects of the invention the illuminator comprises a coaxial illuminator, a diffuse illuminator, or a back illuminator.

In accordance with yet another aspect of the invention the coaxial illuminator illuminates the object through the objective lens.

In accordance with a still further aspect of the invention the camera is either an analog or digital camera and includes a shutter which may be a mechanical shutter.

In accordance with a still further aspect of the invention the camera has a sensor such as a CCD sensor that is characterized by an integration period and that has a reset function.

In accordance with one aspect of the invention the shutter is opened for a period less than the integration period and the optical range sensor is activated while the shutter is closed.

The novel aspects of the invention are set forth with particularity in the appended claims. The invention itself together with further objects and advantages thereof may be more readily understood by reference to the following detailed description of the invention taken in conjunction with the accompanying drawing.

### BRIEF DESCRIPTION OF THE SEVERAL VIEWS OF THE DRAWING(S)

FIG. 1 is a schematic drawing of the apparatus in accordance with the invention; and

FIG. 2 is a timing diagram showing the sequence of operation of the elements of the invention shown in FIG. 1; and

FIG. 3 is a graphical representation showing the object contour, the range sensor output, and the focus position superimposed over the object contour.

### DETAILED DESCRIPTION OF THE INVENTION

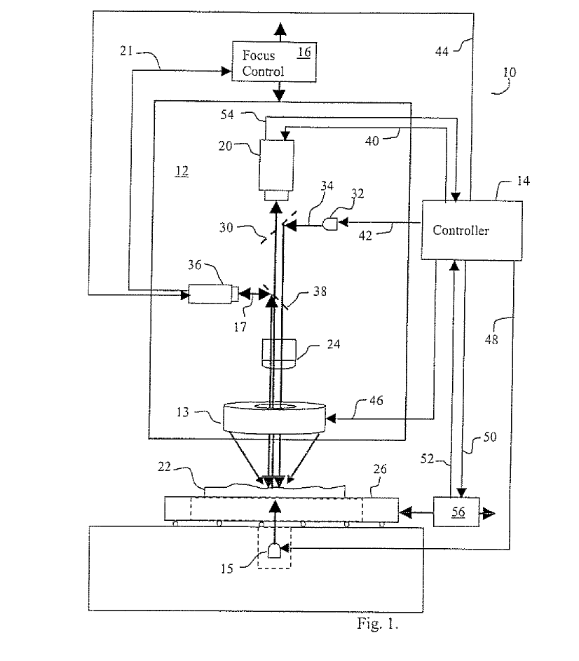

Referring now to FIG. 1, apparatus for sequentially imaging an object while maintaining focus is shown in diagramatic form. The apparatus indicated generally at 10 includes a camera platform 12, a sequencing controller 14, and a focus controller 16.

A camera 20 which is preferably a high resolution camera having a solid-state image sensor producing either an analog or digital output signal is mounted on camera platform 12. Preferably, camera 20 acquires an image of an object 22 being viewed through an objective lens 24. The object being viewed is shown mounted on a movable stage 26 oriented perpendicular to the optical axis of the camera 20 and the objective lens 24. While it is preferred that the stage 26 move relative to the camera platform, it should be understood that the camera platform could move relative to the stage or both could move.

As can be seen, the object 22 being viewed has an irregular surface such that the distance between the camera and the surface varies as the object 22 is moved by the stage 26. The extent of the irregularities is exaggerated somewhat in FIG. 1. A typical application for apparatus in accordance with this invention is the inspection of printed circuit boards. Printed circuit boards may be warped or have irregularities on the surface caused by the formation of metal traces, the weight of the components mounted to the board, or the board's own weight. Moreover, the differences in the coefficients of thermal expansion of the various layers of the board and the like may cause potato-chip-like warping. The printed circuit board may also be mounted on stage 26 in a tilted way that causes the distance from the camera to the surface of the printed circuit board to vary as the stage moves. This invention compensates for all of these effects.

An illuminator 32, preferably a coaxial illuminator, is mounted on the camera platform and directs an illumination beam 34 towards the surface of the object 22 being viewed by way of a first beam splitter 30. Beam splitter 30 allows the image being acquired to pass through the beam splitter 30 while at the same time reflecting illumination from the coaxial illuminator to the surface of the object 22 being viewed. This arrangement ensures that the light beam from the illuminator impinges on the surface of the object being viewed at the location being imaged by the camera 20.

While a coaxial illuminator arranged as described is presently preferred, other types of illuminators may be employed, either alone or in combination with one another. For example, a diffuse illuminator in the form of a ring light 13, either surrounding the object being viewed or mounted on the camera platform and surrounding the objective lens, may be employed either alone, or together with the coaxial illuminator. Various types of ring lights may be employed such as lights having white light sources or lights having red, green, and blue light sources that are combined to produce a substantially white light. In specialized applications colors other than white may be used where desired.

Alternatively, depending upon the nature of the object being viewed, a back illuminator 15 providing light from behind the object being viewed may be employed.

As the object being viewed is translated with respect to the camera platform, and the surface irregularities or warping move the surface of the object being viewed closer to or farther from the camera, and as any tilt or slope in the object being viewed changes the distance from the camera, it is desirable to adjust the distance from the camera to the surface of the object being viewed to maintain optimum focus.

In accordance with one aspect of this invention the device is maintained in focus by moving the camera platform 12 with respect to the object being viewed. This adjustment may be made by moving the entire platform, or by other methods of maintaining focus. It will be understood that the distance from the camera to the surface of the object may be adjusted by moving either the camera or the object or both.

Preferably the distance between the camera and the surface of the object being viewed is measured substantially continuously by a range sensor 36. Range sensor 36, which is preferably a laser range sensor, emits a beam of light 17 that is reflected through the objective lens 24 by a second beam splitter 38. The range sensor beam is reflected from the surface of the object being viewed back through the objective lens, off the surface of the beam splitter 38, and back to the range sensor 36, which measures the distance in a manner well known to those skilled in the art. While a laser range sensor is presently preferred, as used in connection with this invention range sensor is intended to be interpreted more broadly to include any sensor that permits a focused position to be acquired and maintained. For example, linear and nonlinear sensors are intended to be included along with sensors that provide a signal that indicates either the magnitude, or the magnitude and direction of the deviation from the sharply focused position.

In accordance with a presently preferred embodiment of the invention, a beam splitter 38 is provided that reflects virtually all red light back to the range sensor but transmits the rest of the light through the optics to the camera. Using a light source having a non red component, such as an orange light emitting diode, permits gathering a much higher percentage of the light back to the optics than if a neutral density beam splitter and a white light were used. It also allows for the elimination of the use of infrared filters at or near the camera since the beam splitter already blocks the infrared light. Infrared filters have been used in machine vision cameras to block stray infrared light entering the system from uncontrolled sources which degrade imaging performance.

Preferably, the range sensor produces a signal 21 that is a measure of the deviation of the actual distance from the optimum focus distance and provides that error signal 21 to a focus controller 16, which adjusts the position of the camera platform 12 to maintain optimum focus. The range sensor signal 21 can also be used for measuring the height variation of the object while gathering images.

It is preferred that the light beam produced by the range sensor 36 have a wavelength that permits it to be detected by the camera 20 so that the camera can be used to ensure that the range sensor beam is within the area being imaged so as to maintain the best possible focus. By using a range sensor beam that can be imaged by the camera the range sensor can be adjusted by viewing the image produced by the camera and setting the range sensor beam so that it impinges upon the surface of the object being viewed at or near the center of the image being acquired. While laser range sensors are preferred, nonlaser range sensors utilizing white light or lights of other colors may also be employed.

Each of camera 20, illuminators 32, 13, 15 and range sensor 36 is provided with a control input 40, 42, 46, 48 and 44 respectively. Input 40 controls the operation of camera 20 by switching the camera between a first mode for capturing an image and the second mode for which image capture is inhibited. The manner of switching the camera depends upon the nature of the sensor provided in the camera, but where a CCD sensor is provided the camera may be switched between an image capture mode and a standby mode by adjusting the bias to the CCD sensor.

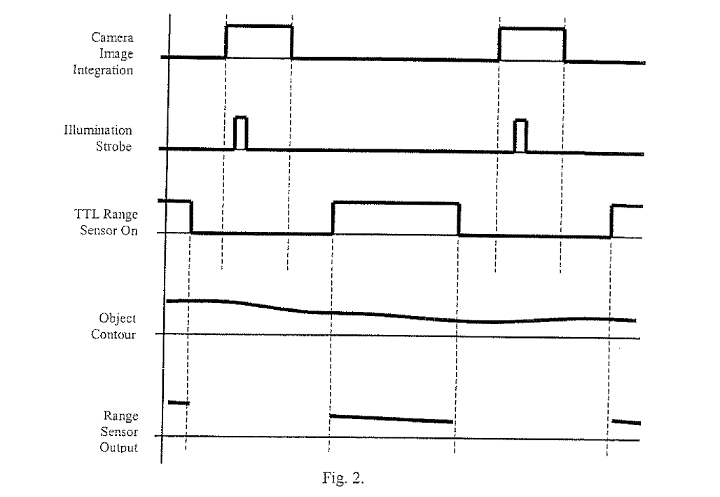

This paragraph seems redundant to the next paragraph; the following paragraph seems clearer.]The control inputs 40, 42, 44, 46, and 48 are connected to controller 14. Controller 14 selects and deselects the camera image capture mode, turns the illuminators, 13, 15, and 32 on and off, and activates and deactivates the range sensor 36. FIG. 2 is a timing diagram showing the operation of controller 14.

While as described, various types of range sensors may be employed in the practice of this invention, visible light range sensors, either white light emitting sources, or colored sources that produce visible light, are presently preferred. Visible light range finders are visible to the camera and allow the rangefinder beam to be easily centered in the camera's field of view. Visible light range sensors such as white light or even visible red light are also preferred over wavelengths outside the visible region so that users are aware of the presence of the range sensor light, which might otherwise be damaging to the eye of the user and not visible.

Cameras responsive to visible light are presently preferred because they produce an image, which, if viewed directly, looks like what the user would expect to see.

Referring to FIG. 2, which is not drawn to scale, the range sensor 36 is activated substantially continuously, except when image capture is actually taking place. The period of time during which the range sensor is activated may be substantially greater than appears from the drawing because of the scale. It is desirable in accordance with this invention that the range sensor be activated for as much of the time as possible. However, the range sensor is deactivated periodically to allow an image to be captured. Alternatively, the range sensor may be activated intermittently as the stage 26 positions the object 22 at locations where image capture is desired.

Camera 20 is placed in the image capture mode shortly after range sensor 36 is deactivated. Preferably, sufficient time is allowed to elapse between the time the range sensor 36 is deactivated and the time that the camera 20 is placed into the image acquisition mode so that substantially no light from the range sensor will be detected by the camera.

A short time after the camera is placed in the image capture mode by the application of an appropriate signal to input 40, strobed illuminator 32 is activated by a signal 42 and the strobed illuminator flashes. The ring light 13 may also be strobed by signal 46 at the same time as strobe iluminator 32. The camera 20 acquires an image during the period that the strobed illuminator 32 is on and integrates that image during a period commencing when the strobed illuminator turns on, and ending when the camera is deactivated. Following deactivation of the camera the range sensor 36 is again activated and remains on until the next image is acquired.

Motion controller 14 controls the position of a stage 26 by supplying an actuator signal 50 to the actuator 56 and receiving a position signal 52 from the actuator. Preferably, controller 14 initiates image capture at specific predetermined positions along the path of stage 26. The predetermined positions may be equally spaced or spaced in accordance with predetermined criteria to capture images at desired locations. As already discussed, it is preferred that the range sensor operate substantially continuously, but if the range sensor is set to operate intermittently then the range sensor is activated as the stage approaches each of the predetermined positions. Once the range sensor is activated controller 14 activates the stroboscopic illuminator and the camera in the manner and sequence described above.

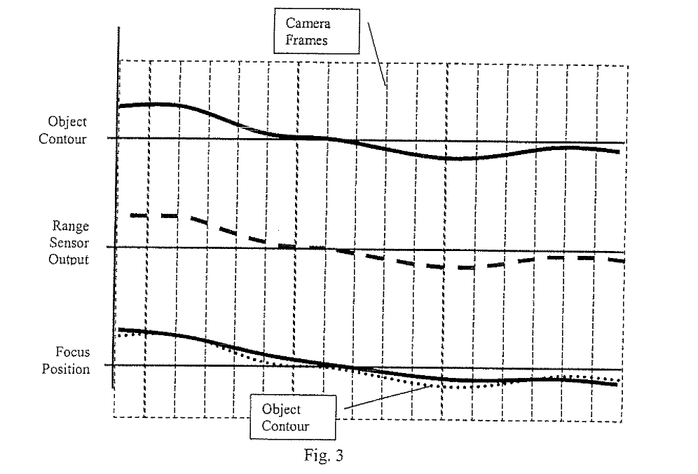

FIG. 3 is a graphical representation showing the object contour, the range sensor output, and the focus position superimposed over the object contour. As can be seen, the range sensor output is periodically interrupted during image acquisition. By integrating the range sensor output as described above the focus position can be maintained relatively accurately with respect to the actual object contour as shown in the graph.

While it is preferred to utilize cameras that have reset capability in accordance with this invention, the invention also permits the use of cameras without reset capability. Such cameras are preferably configured to capture a continuous sequence of images in a plurality of camera frames separated by vertical refresh intervals. Controller 14 receives a signal 54 from the camera indicating the state of the camera, that is whether the camera is in an image capture frame or a vertical refresh interval. The stroboscopic illuminator is sequenced by controller 14 to operate during every frame or during preselected camera frames and is inhibited from operating during vertical refresh intervals when no image can be acquired by the camera.

While the invention has been described in accordance with a presently preferred embodiment thereof, those skilled in the art will recognize that various modifications and changes may be made in the invention without departing from the true spirit and scope thereof, which accordingly is intended to be defined solely by the appended claims.

1. Apparatus for sequentially imaging an object while maintaining focus comprising:
a camera having a selectable image capture mode;
an objective lens optically coupled to the camera;
an optical range sensor operating through the objective lens;
a strobe illuminator; and
a controller coupled to the camera, the illuminator, and the range sensor sequentially activating and deactivating the range sensor, selecting and deselecting the image capture mode only when the range sensor is deactivated, and activating and deactivating the strobe illuminator only when the image capture mode is active.

2. The apparatus of claim 1 comprising a focus controller coupled to the range sensor.

3. The apparatus of claim 1 in which the illuminator comprises a coaxial illuminator.

4. The apparatus of claim 1 in which the illuminator comprises a multi-spectral illuminator.

5. The apparatus of claim 4 in which the illuminator comprises a red light emitting element and a non-red light emitting element.

6. The apparatus of claim 3 in which the illuminator is coupled to the objective lens.

7. The apparatus of claim 1 in which the illuminator comprises a diffuse illuminator.

8. The apparatus of claim 1 in which the illuminator comprises a back illuminator.

9. The apparatus of claim 1 in which the camera comprises a digital camera.

10. The apparatus of claim 1 in which the camera comprises an analog camera.

11. The apparatus of claim 1 in which the camera comprises a shutter.

12. The apparatus of claim 11 in which the shutter comprises a signal that deactivates the camera.

13. The apparatus of claim 12 in which the camera comprises a sensor and the signal comprises a bias signal.

14. The apparatus of claim 11 in which the shutter comprises an optical shutter.

15. The apparatus of claim 11 in which the shutter comprises a mechanical shutter.

16. The apparatus of claim 11 in which the camera comprises a sensor characterized by integration period.

17. The apparatus of claim 16 in which the camera comprises a reset function.

18. The apparatus of claim 16 in which the shutter is open for a period less than the integration period.

19. The apparatus of claim 18 in which the shutter is closed and the optical range sensor is activated during the integration period.

20. The apparatus of claim 1 in which the optical range sensor comprises a red light sensitive sensor and further comprising a red light discriminating beam splitter.

21. The apparatus of claim 20 in which the range sensor comprises a light source emitting red light and at least one other color of light.

22. The apparatus of claim 1 in which the optical range sensor comprises a laser triangulation based sensor.

23. The apparatus of claim 2 in which the focus controller operates substantially continuously, even while the optical range sensor is deactivated.

24. The apparatus of claim 23 in which the focus controller comprises an integrator.

25. The apparatus of claim 23 in which the focus controller comprises a low-pass filter.

26. A method for sequentially imaging an object while maintaining focus comprising:
providing a camera having a selectable image capture mode;
providing an objective lens optically coupled to the camera;
providing an optical range sensor operating through the objective lens;
providing a strobe illuminator; and
sequentially activating and deactivating the range sensor, selecting and deselecting the image capture mode only when the range sensor is deactivated, and activating and deactivating the strobe illuminator only when the image capture mode is active.

27. The method of claim 26 in which activating and deactivating the camera comprises sending a signal to the camera that deactivates and activates the camera.

28. The method of claim 27 in which the signal comprises a bias signal.

29. The method of claim 26 in which the range sensor provides an output signal and further comprising integrating the output signal over an integration period.

30. The method of claim 29 comprising activating the camera for a period less than the integration period.

31. The method of claim 30 comprising deactivating the camera and activating the optical range sensor during the integration period.
